(19) United States
(12) Patent Application Publication
(10) Pub. No.: US 2017/0305062 A1
(43) Pub. Date: Oct. 26, 2017

(54) METHOD FOR PREPARING HOT STAMPING HOLLOW CYLINDRICAL EPE SLIVER IN 360 DEGREE

(71) Applicant: Dongguan Xute Plastic Technology Co.Ltd., Dongguan (CN)

(72) Inventor: Xubin Xia, Dongguan (CN)

(73) Assignee: Dongguan Xute Plastic Technology Co.Ltd., Dongguan (CN)

(21) Appl. No.: 15/463,384

(22) Filed: Mar. 20, 2017

(30) Foreign Application Priority Data
Apr. 20, 2016 (CN) 2016102482313

(51) Int. Cl. B29C 59/02; B05B 9/04; B29C 59/00; B29K 1/00

(52) U.S. Cl. CPC B29C 59/021; B29C 59/002; B05B 9/0413; B29K 2001/00

(57) ABSTRACT

A method for preparing hot stamping cylindrical EPE sliver, including the following steps: Step 1, prepare a hot stamping die: an annular pattern, which is annular and will be stamped on the surface of a hollow cylindrical EPE sliver, is expanded as a planar pattern to prepare a flat stamping die. Step 2, the flat stamping die is installed on a heating device of a hot stamping machine, and a hot stamping temperature is adjusted. Step 3, the hollow cylindrical EPE sliver is set in a rotation axis of the stamping machine. Step 4, form a figuration by extruding each other when the rotating EPE sliver figuration passes through said hot stamping pattern on said stamping die. Step 5, the rotational speed of the rotation axis and the horizontal speed are set equally. Step 6, start-up a hot stamping button, therefore resulting in perfect hot stamping in 360 degree.

### FIELD OF THE INVENTION

The present invention relates to the technical field of the method for preparing hot stamping EPE sliver, and particularly relates to a method for preparing hot stamping cylindrical EPE sliver in 360 degree.

### BACKGROUND OF THE INVENTION

EPE sliver (also named pearl cotton) surface hot stamping technology has been applied for many years. At present, the stamping technology usually adopts vertical stamping method, that is the hot stamping sliver is fixed, and the hot stamping mold moves up and down. This method can be used on the flat surface of EPE sliver. However, on the curved surface of the EPE sliver the hot stamping pattern will be deformed in some degree with this method. If the radian exceeds some value, the hot stamping can't be carried out and therefore the hot stamping range is limited. EPE circular sliver itself is formed by the extrusion foaming of PE particles, the tolerance of the external diameter size is also larger, which also increases the difficulty for stamping in 360 degree. The EPE sliver with different external diameter size must be produced with different hot stamping mold. It increases the processing cost.

Therefore, it is necessary to provide a method for preparing hot stamping hollow cylindrical EPE sliver in 360 degree to resolve the shortcomings of the prior art.

### SUMMARY OF THE INVENTION

The object of the present invention is to provide a method for preparing hot stamping hollow cylindrical EPE sliver in 360 degree, to expand using field of sliver and achieve perfect hot stamping of hollow cylindrical EPE sliver in 360 degree.

For achieving the above object, the technologies of the present invention are as follows:

A method for preparing hot stamping hollow cylindrical EPE sliver in 360 degree comprises the follow steps:

Step 1, prepare a hot stamping die: an annular pattern, which is annular and will be stamped on surface of a hollow cylindrical EPE sliver, is expanded as a planar pattern to prepare a flat stamping die;

Step 2, the flat stamping die is installed on a heating device of a hot stamping machine, and a hot stamping temperature is adjusted;

Step 3, the hollow cylindrical EPE sliver is set in a rotation axis of the stamping machine, wherein the rotation axis can both rotate at constant speed and move in horizontal direction. The rotation speed and the horizontal speed are precise and adjustable;

Step 4, the height of the hot stamping pattern or the height of the rotational axis is adjusted according to the external diameter size of the hot stamping EPE sliver or the depth of the hot stamping pattern, therefore forming a figuration by extruding each other when the rotating EPE sliver figuration passes through said hot stamping pattern on said stamping die;

Step 5, the rotational speed of the rotation axis and the horizontal speed are set equally; the setting condition of both speed is that the rotation axis rotates a circle, the distance that the rotation axis moves at horizontal direction is equal to the width of the hot stamping die pattern on the stamping die;

Step 6, start-up a hot stamping button, the EPE sliver is rotating at the same time moving at a horizontal direction to pass through the surface of the hot stamping die pattern, the EPE sliver and the hot stamping die extrude each other. The surface of the sliver is left the same pattern, therefore resulting perfect hot stamping in 360 degree.

Specifically, in step 2, the hot stamping temperature is between 80-150° C.

Specifically, in step 2, the heat device can be adjusted up and down.

Specifically, the rotation axis is tightly connected with the inner wall of the EPE sliver that sets outside of itself.

Specifically, the location of the rotation axis can be adjusted up and down.

The other object of the present invention is to provide a piston water gun with stamping EPE sliver in 360 degree. A piston water gun with stamping EPE sliver in 360 degree includes a base, a piston and a piston cylinder; the piston cylinder has a cylinder body and a lid. One end of the cylinder body is sealed by the lid, the other end of the cylinder is opening; The lid of the piston is set through a hole to connect into the inner cavity of the cylinder body; one end of the piston fixedly connects to the base, the other end of the piston enters the inner of the cylinder from the opening and tight slipply fits with the inner wall of the cylinder; the outsides of the piston cylinder set a first stamping EPE sliver. The outsides of the base set a second stamping EPE sliver; the first stamping EPE sliver has a first mating surface, the second stamping EPE sliver has a second mating surface; the first mating surface and the second mating surface are correspondingly arranged and matched with each other. Both of the first mating surface and the second mating surface are planet.

The first stamping EPE sliver is set a lid groove where the lid of the piston contains.

The base has a cylindrical base and a base cover setting in one side of the cylindrical base; the base cover has a side edge extending out of the cylindrical base; the second stamping EPE sliver is set the cylindrical base and fixedly connected to the side edge.

The cylindrical base sets a socket, the socket has a first ring wall and a second ring wall; the piston fixedly connects to the inner of the first ring wall; the opening of the cylinder body is set on the second ring wall.

Both of the first stamping EPE sliver and the second stamping EPE sliver have stamped color picture.

The present invention discloses a method for hot stamping hollow cylindrical EPE sliver in the range of 360 degree, comprising the following steps: step 1, prepare a hot stamping die: an annular pattern, which is annular and will be stamped on surface of a hollow cylindrical EPE sliver, is expanded as a planar pattern to prepare a flat stamping die; step 2, the stamping die is installed on a heating device of a hot stamping machine, and a hot stamping temperature is adjusted; step 3, the hollow cylindrical EPE sliver is set in a rotation axis of the stamping machine, the rotation axis can both rotate and move in horizontal direction. The rotation speed and the horizontal speed are precise and adjustable; step 4, the height of the hot stamping pattern or the height of the rotational axis is adjusted according to the external diameter size of said hot stamping EPE sliver or the depth of said hot stamping pattern, therefore forming figuration by extruding each other when the rotating EPE sliver figuration passes through said hot stamping pattern on said stamping die; step 5, the rotational speed of the rotation axis and the horizontal speed are set equally; the setting condition of both speeds is that the rotation axis rotates a circle, the distance that the rotation axis moves at horizontal direction is equal to the width of the hot stamping die pattern; step 6, start-up the hot stamping button, the EPE sliver is rotating at the same time moving at a horizontal direction to pass through the surface of the hot stamping die, the EPE sliver and the hot stamping die pattern extrude each other, the surface of the sliver is left the same pattern, therefore resulting perfect hot stamping in 360 degree. Compared with the prior art, in the method for hot stamping hollow cylindrical EPE sliver in the range of 360 degree in the present invention, the hot stamping pattern can be designed according to need, thus the hot stamping die with the corresponding pattern can be manufactured, then the hot stamping die is fixed on the hot stamping device, the hot stamping die is not moved, the hollow cylindrical EPE sliver, that will be hot stamping, rotates at constant speed and moves in horizontal direction and extrudes each other with the hot stamping die for achieving accurate and informal hot stamping in 360 degree on the surface of EPE sliver. Completely no any interface can be seen. It expands the using fields of the silver, and the pattern has depth of agreement. Its appearance is really beautiful.

The advantages of the Utility Model are as follows: the piston water gun with stamping EPE sliver in 360 degree. The outsides of the plastic cylindrical water storage pipe is set a stamping EPE sliver, the outside wall of the stamping EPE sliver is printed with color pictures, thus it enriches the appearance of the water gun and satisfies market demands.

### BRIEF DESCRIPTION OF THE DRAWINGS

FIG. 1 shows the view of the piston water gun with stamping EPE sliver in 360 degree in present invention.

FIG. 2 shows the exploded view of the piston water gun with stamping EPE sliver in 360 degree in present invention.

FIG. 3 shows the exploded view of a base 10 in the piston water gun with stamping EPE sliver in 360 degree in present invention.

### DETAILED DESCRIPTION OF ILLUSTRATED EMBODIMENTS

### Example 1

The method for preparing hot stamping hollow cylindrical EPE sliver in the range of 360 degree comprises the follow steps:

Step 1, prepare a hot stamping die: an annular pattern, figuration by extruding each other when the rotating EPE sliver figuration passes through said hot stamping pattern on said stamping die;

Step 2, the flat stamping die is installed on a heating device of a hot stamping machine, and a hot stamping temperature is adjusted to 80° C.;

Step 3, the hollow cylindrical EPE sliver is set in a rotation axis of the stamping machine, the rotation axis can both rotate at constant speed and move in horizontal direction. The rotation speed and the horizontal speed are precise and adjustable;

Step 4, the height of the hot stamping pattern or the height of the rotational axis is adjusted according to the external diameter size of the hot stamping EPE sliver or the depth of said hot stamping pattern, therefore forming a figuration by extruding each other when the rotating EPE sliver figuration passes through said hot stamping pattern on said stamping die;

Step 5, the rotational speed of the rotation axis and the horizontal movement speed are set equally; the set condition of both speed is that the rotation axis rotates a circle, the distance that the rotation axis moves at horizontal direction is equal to the width of the hot stamping die pattern on the stamping die;

Step 6 start-up the hot stamping button, the EPE sliver is rotating at the same time moving at a horizontal direction to pass through the surface of the hot stamping die pattern, the EPE sliver and the hot stamping die extrude each other. The surface of the sliver is left the same pattern, therefore resulting perfect hot stamping in 360 degree.

Specifically, in step 2, the heat device can be adjusted up and down.

Specifically, the rotation axis is tightly connected with the inner wall of the EPE sliver that sets outside of itself.

Specifically, the location of the rotation axis can be adjusted up and down.

### Example 2

The method for hot stamping hollow cylindrical EPE sliver in the range of 360 degree, comprises the follow steps:

Step 1, prepare a hot stamping die: an annular pattern, figuration by extruding each other when the rotating EPE sliver figuration passes through said hot stamping pattern on said stamping die;

Step 2, the flat stamping die is installed on a heating device of a hot stamping machine, and a hot stamping temperature is adjusted to 100° C.;

Step 3, the hollow cylindrical EPE sliver is set in a rotation axis of the stamping machine, the rotation axis can both rotate at constant speed and move in horizontal direction. The rotation speed and the horizontal speed are precise and adjustable;

Step 4, the height of the hot stamping pattern or the height of the rotational axis is adjusted according to the external diameter size of the hot stamping EPE sliver or the depth of the hot stamping pattern, therefore forming figuration by extruding each other when the rotating EPE sliver figuration passes through said hot stamping pattern on said stamping die;

Step 5, the rotational speed of the rotation axis and the horizontal movement speed are set equally; the set condition of both speed is that the rotation axis rotates a circle, the distance that the rotation axis moves at horizontal direction is equality to the width of the hot stamping die pattern on the stamping die;

Step 6, start-up the hot stamping button, the EPE sliver is rotating at the same time moving at a horizontal direction to pass through the surface of the hot stamping die pattern, the EPE sliver and the hot stamping die extrude each other. The surface of the sliver is left the same pattern, therefore resulting perfect hot stamping in 360 degree.

Specifically, in step 2, the heat device can be adjusted up and down.

Specifically, the rotation axis is tightly connected with the inner wall of the EPE sliver that is set outside itself.

Specifically, the location of the rotation axis can be adjusted up and down.

### Example 3

The method for hot stamping hollow cylindrical EPE sliver in the range of 360 degree, comprises the follow steps:

Step 1, prepare a hot stamping die: an annular pattern, figuration by extruding each other when the rotating EPE sliver figuration passes through said hot stamping pattern on said stamping die;

Step 2, the flat stamping die is installed on a heating device of a hot stamping machine, and a hot stamping temperature is adjusted to 120° C.;

Step 3, the hollow cylindrical EPE sliver is set in a rotation axis of the stamping machine, the rotation axis can both rotate at constant speed and move in horizontal direction. The rotation speed and the horizontal speed are precise and adjustable;

Step 4, the height of the hot stamping pattern or the height of the rotational axis is adjusted according to the external diameter size of the hot stamping EPE sliver or the depth of the hot stamping pattern, therefore forming a figuration by extruding each other when the rotating EPE sliver figuration passes through said hot stamping pattern on said stamping die;

Step 5, the rotational speed of the rotation axis and the horizontal movement speed are set equally; the set condition of both speed is that the rotation axis rotates a circle, the distance that the rotation axis moves at horizontal direction is equal to the width of the hot stamping die pattern on the stamping die;

Step 6, start-up the hot stamping button. The EPE sliver is rotating at the same time moving at a horizontal direction to pass through the surface of the hot stamping die pattern, the EPE sliver and the hot stamping die extrude each other, the surface of the sliver is left the same pattern, therefore resulting perfect hot stamping in 360 degree.

Specifically, in step 2, the heat device can be adjusted up and down.

Specifically, the rotation axis is tightly connected with the inner wall of the EPE sliver that is set outside itself.

Specifically, the location of the rotation axis can be adjusted up and down.

### Example 4

The method for hot stamping hollow cylindrical EPE sliver in the range of 360 degree, comprises the follow steps:

Step 1, prepare a hot stamping die: an annular pattern, figuration by extruding each other when the rotating EPE sliver figuration passes through said hot stamping pattern on said stamping die;

Step 2, the flat stamping die is installed on a heating device of a hot stamping machine, and a hot stamping temperature is adjusted to 150° C.;

Step 3, the hollow cylindrical EPE sliver is set in a rotation axis of the stamping machine, the rotation axis can both rotate at constant speed and move in horizontal direction. The rotation speed and the horizontal speed are precise and adjustable;

Step 4, the height of the hot stamping pattern or the height of the rotational axis is adjusted according the external diameter size of the hot stamping EPE sliver or the depth of the hot stamping pattern, therefore forming a figuration by extruding each other when the rotating EPE sliver figuration passes through said hot stamping pattern on said stamping die;

Step 5, the rotational speed of the rotation axis and the horizontal movement speed are set equally; the set condition of both speed is that the rotation axis rotates a circle, the distance that the rotation axis moves at horizontal direction is equal to the width of the hot stamping die pattern on the stamping die;

Step 6, start-up the hot stamping button. The EPE sliver is rotating at the same time moving at a horizontal direction to pass through the surface of the hot stamping die pattern, the EPE sliver and the hot stamping die extrude each other, the surface of the sliver is left the same pattern, therefore resulting perfect hot stamping in 360 degree.

Specifically, in step 2, the heat device can be adjusted up and down.

Specifically, the rotation axis is tightly connected with the inner wall of the EPE sliver that is set outside itself.

Specifically, the location of the rotation axis can be adjusted up and down.

The present invention discloses a method for hot stamping hollow cylindrical EPE sliver in the range of 360 degree, comprising the follow steps:

Step 1, prepare a hot stamping die: an annular pattern, which is annular and will be stamped on surface of a hollow cylindrical EPE sliver, is expanded as a planar pattern to prepare a flat stamping die. Step 2, the flat stamping die is installed on a heating device of a hot stamping machine, and a hot stamping temperature is adjusted. Step 3, the hollow cylindrical EPE sliver is set in a rotation axis of the stamping machine, the rotation axis can both rotate at constant speed and move in horizontal direction, the rotation speed and the horizontal speed are precise and adjustable. Step 4, the height of the hot stamping pattern or the height of the rotational axis is adjusted according to the external diameter size of the hot stamping EPE sliver or the depth of the hot stamping pattern, therefore forming a figuration by extruding each other when the rotating EPE sliver figuration passes through said hot stamping pattern on said stamping die. Step 5, the rotational speed of the rotation axis and the horizontal speed are equal; the setting condition of both speeds is that the rotation axis rotates a circle, the distance that the rotation axis moves at horizontal direction is equal to the width of the hot stamping die pattern on the stamping die. Step 6, start-up a hot stamping button. The EPE sliver is rotating at the same time moving at a horizontal direction to pass through the surface of the hot stamping die pattern, the EPE sliver and the hot stamping die extrude each other, the surface of the sliver is left the same pattern, therefore resulting perfect hot stamping in 360 degree. Completely no any interface can be seen, and the pattern has depth of agreement. Its appearance is really beautiful.

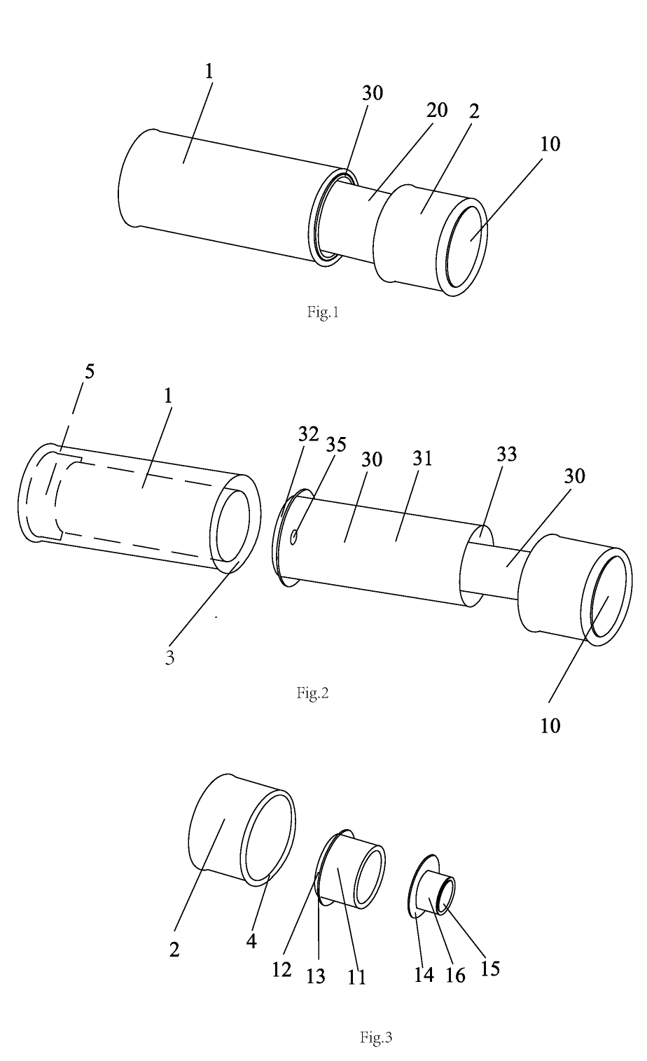

Referring to FIG. 1 and FIG. 2, a piston water gun with stamping EPE sliver in 360 degree includes a base 10, a piston 20 and a piston cylinder 30, a first stamping EPE sliver 1 and a second stamping EPE sliver 2.

The piston cylinder 30 has a cylinder body 31 and a lid 32; one end of the cylinder body 31 is sealed by the lid 32; the other end of the cylinder 31 is opening; the lid 32 of the piston is set through a hole 35 to connect into the inner cavity of the cylinder body 31; one end of the piston 20 fixedly connects to the base 10; the other end of the piston 20 enters the inner of the cylinder 31 from the opening and tight sliply fits with the inner wall of the cylinder 31; the outsides of the piston cylinder 30 set the first stamping EPE sliver 1; the outsides of the base 10 set the second stamping EPE sliver 2; the first stamping EPE sliver 1 has a first mating surface 3; the second stamping EPE sliver 2 has a second mating surface 4; the first mating surface 3 and the second mating surface 4 are correspondingly arranged and matched with each other.

Preferably, both of the first mating surface 3 and the second mating surface 4 are plane, thus benefiting the cooperation of the first mating surface 3 and the second mating surface 4. When the piston 20 of the piston water gun contains in the cylinder body 31, the first mating surface 3 contacts with the second mating surface 4, thus the first stamping EPE sliver 1 and the second stamping EPE sliver 2 combine as a whole. The appearance of the water gun is beautiful.

Preferably, the first stamping EPE sliver 1 sets a lid groove 5 where the lid of the piston contained.

Preferably, referring to FIG. 1, the base 10 has a cylindrical base 11 and a base cover 12 setting in one side of the cylindrical base 11; the base cover 12 has a side edge 13 extending out the cylindrical base 11; the second stamping EPE sliver 2 set the cylindrical base 11 and fixedly connect to the side edge 13, thus the second stamping EPE sliver 2 is fixed and avoided to taking off from the base.

Preferably, the cylindrical base 11 has a socket 14, the socket 14 has a first ring wall 15 and a second ring wall 16; the piston 20 fixedly connects to the inner of the first ring wall 15, the opening of the cylinder body 31 sets the outsides of the second ring wall 16, therefore benefiting the fit connection of the cylinder body 31 and the socket 14.

Preferably, the first stamping EPE sliver 1 and the second stamping EPE sliver 2 have stamped color picture.

While the specification has described in detail certain exemplary embodiments, it will be appreciated that those skilled in the art, upon attaining an understanding of the foregoing, may readily conceive of alterations to, variations of, and equivalents to these embodiments.

What is claimed:

1. A method for preparing hot stamping hollow cylindrical EPE sliver in 360 degree, comprising the following steps:
Step 1, prepare a hot stamping die: an hot stamping pattern, which is annular and will be stamped on surface of a hollow cylindrical EPE sliver, is expanded as a planar pattern to prepare a flat stamping die;
Step 2, said flat stamping die is installed on a heating device of a hot stamping machine, and a hot stamping temperature is adjusted;
Step 3, said hollow cylindrical EPE sliver is set in a rotation axis of said stamping machine, wherein said rotation axis can both rotate at a constant speed and move in horizontal direction, said rotation speed and said horizontal speed are precise and adjustable;
Step 4, the height of said hot stamping pattern or the height of said rotational axis is adjusted according to the external diameter size of said hot stamping EPE sliver or the depth of said hot stamping pattern, therefore forming a figuration by extruding each other when said rotating EPE sliver passes through said hot stamping pattern on said stamping die;
Step 5, said rotational speed of said rotation axis and said horizontal speed are equal; the setting condition of both speeds is that when said rotation axis rotates a circle, the distance that said rotation axis moves at horizontal direction is equal to the width of said hot stamping pattern on said stamping die;
Step 6, start-up a hot stamping button, said EPE sliver is rotating at the same time moving at a horizontal direction to pass through the surface of said hot stamping pattern, wherein said EPE sliver and said hot stamping die extrude each other, said surface of said sliver is left the same pattern, therefore resulting perfect hot stamping in 360 degree.

2. A method for preparing hot stamping hollow cylindrical EPE sliver in 360 degree according to claim 1, wherein in Step 2, said hot stamping temperature is between 80-150° C.

3. A method for preparing hot stamping hollow cylindrical EPE sliver in 360 degree according to claim 1, wherein in Step 2, said heating device can be adjusted up and down.

4. A method for preparing hot stamping hollow cylindrical EPE sliver in 360 degree according to claim 1, wherein said rotation axis is tightly connected with the inner wall of the EPE sliver that sets outside itself.

5. A method for preparing hot stamping hollow cylindrical EPE sliver in 360 degree according to claim 1, wherein the location of said rotation axis can be adjusted up and down.

6. A piston water gun with stamping EPE sliver in 360 degree, including a base, a piston and a piston cylinder; said piston cylinder has a cylinder body and a lid; one end of said cylinder body is sealed by said lid, the other end of said cylinder is opened; said lid of the piston is set through a hole to connect into the inner cavity of said cylinder body; one end of said piston fixedly connects to said base; the other end of said piston enters the inner of said cylinder from said opening and tight slipply fits with the inner wall of said cylinder; the outsides of said piston cylinder is set a first stamping EPE sliver.

7. A piston water gun with stamping EPE sliver in 360 degree according to claim 6, wherein the outsides of said base are set a second stamping EPE sliver; said first stamping EPE sliver has a first mating surface, said second stamping EPE sliver has a second mating surface; said first mating surface and said second mating surface are correspondingly arranged and matched with each other.

8. A piston water gun with stamping EPE sliver in 360 degree according to claim 6, wherein said first stamping EPE sliver is set a lid groove where said lid of said piston contains.

9. A piston water gun with stamping EPE sliver in 360 degree according to claim 6, wherein both of said first mating surface and said second mating surface are planet.

10. A piston water gun with stamping EPE sliver in 360 degree according to claim 6, wherein said base has a cylindrical base and a base cover setting in one side of said cylindrical base; said base cover has a side edge extending out of said cylindrical base; said second stamping EPE sliver is set said cylindrical base and fixedly connected to said side edge.

11. A piston water gun with stamping EPE sliver in 360 degree according to claim 6, wherein said cylindrical base is set a socket, said socket has a first ring wall and a second ring wall; said piston fixedly connects to the inner of said first ring wall; said opening of said cylinder body is set said second ring wall.

12. A piston water gun with stamping EPE sliver in 360 degree according to claim 6, wherein both of said first stamping EPE sliver and said second stamping EPE sliver have stamped color picture.
